(19) United States
(12) Patent Application Publication
(10) Pub. No.: US 2003/0216489 A1
(43) Pub. Date: Nov. 20, 2003

(54) Elastomeric compositions containing surface-modified silica gels

(76) Inventors: Meng-Jiao Wang, Lexington, MA (US); Joachim Floess, Urbana, IL (US); Khaled Mahmud, Natick, MA (US)

Correspondence Address: Martha Ann Finnegan, Esq., Cabot Corporation, 157 Concord Road, Billerica, MA, 01821-7001, US

(21) Appl. No.: 10/150,545

(22) Filed: May 17, 2002

(51) Int. Cl. C08K 9/00; C08K 3/34; C08K 3/04

(52) U.S. Cl. 523/216; 524/492; 524/495

(57) ABSTRACT

Rubber compositions containing surface-modified, ambient pressure dried, highly dispersible silica gels are disclosed. Methods of making rubber compositions containing such surface-modified silica gels, and methods of functionalizing the surface-modified silica gel in-situ in the presence of an elastomeric component are also disclosed. Articles, including tires and tire components, made from the reinforced rubber compositions are also disclosed.

### FIELD OF THE INVENTION

The present invention relates to the use of silicas in hydrocarbon rubbers. More particularly, the present invention relates to methods of making elastomeric compositions containing silicas.

### BACKGROUND OF THE INVENTION

U.S. Pat. No. 5,789,514 relates to hydrophobic silica gels that can be used as a reinforcing agent in silicone rubber. The methods described in the patent include at least two steps for forming a hydrophobic silica gel. Preferably, according to the patent, a silica hydrogel is converted to a hydrophobic silica organogel which can then be used as a reinforcing agent. According to U.S. Pat. No. 5,789,514, a specific organosilicon compound is contacted with a silica hydrogel in the presence of a catalytic amount of a strong acid to effect hydrophobing of the silica hydrogel. The hydrophobic silica hydrogel can then be contacted with a sufficient quantity of water-immiscible organic solvent to convert the hydrophobic silica hydrogel into a hydrophobic silica organogel. A need exists for a method of generating a silica gel or aerogel composition that is easily formed, that can be readily dispersed in an elastomeric composition, and that is useful as a reinforcing agent. U.S. Pat. No. 6,068,694 relates to silicon dioxide particles and their use as reinforcing fillers for certain elastomeric compositions. In particular, this patent describes the use of silica fillers in rubber and tire compositions. The patent relates to complicated processes for producing an aggregate of particles for reinforcement of elastomers wherein the process of producing the aggregate includes many costly, time-consuming, and complicated process steps to result in a modified precipitate that can subsequently be added to an elastomeric composition.

A need exists for a method of generating a silica filler that is useful as a reinforcing agent and that can be readily dispersed in an elastomeric composition

The foregoing U.S. patents and all other patents and publications mentioned herein are incorporated herein in their entirety by reference.

### SUMMARY OF THE INVENTION

The present invention provides tire and tire components that contain at least one elastomeric component and at least one surface-modified silica gel. The present invention also provides elastomeric compositions that include at least one surface functionalized (e.g., treated with a coupling agent) silica gel. The present invention also provides a method of producing an elastomeric composition that is reinforced with at least one silica gel filler that is functionalized in-situ upon blending the components of the elastomeric composition. The present invention further provides a surface-modified silica gel reinforcing filler that is more readily dispersible and simpler to generate than previous reinforcing silica gel fillers that require complicated manufacturing steps so as to obtain good dispersion of the silica in the elastomer.

In accordance with the present invention, a method is provided whereby, a silica aerogel that is manufactured by surface treatment and ambient pressure drying and that is surface-functionalized in-situ in an elastomeric composition blend gives improved dispersion of the silica in the rubber and improved polymer filler interactions so as to give improved rubber reinforcement. The blend can subsequently be used for forming elastomeric parts such as tires and tire treads. In accordance with the present invention, the surface functionalization of the silica gel occurs in the presence of the elastomeric component and does not require any complicated surface-functionalization procedures prior to blending with an elastomeric component.

The present invention relates to a method of improving the wet skid resistance of an elastomeric composition by blending the composition with at least one surface modified silica gel and at least one surface-functionalizing agent (e.g., coupling agent) under conditions such that forms a reinforced elastomeric composition that has higher wet skid resistance than the same composition but without having the surface-modified silica gel present or having the same silica gel present but without having been surface-functionalized.

Furthermore, the present invention relates to a method of improving the hysterisis of an elastomeric composition by blending the composition with at least one surface modified silica gel and at least one silica gel surface-functionalizing agent (e.g., coupling agent) under conditions such that forms an elastomeric composition that gives higher wet skid resistance and lower hysterisis at higher temperature than the same composition but without having the surface-modified silica gel present or having the same silica gel present but without having been surface-functionalized.

### DETAILED DESCRIPTION OF THE INVENTION

According to the present invention, a surface-modified silica gel, preferably a surface-modified silica aerogel that is manufactured by end capping of the silica surface hydroxyl groups and subsequently ambient pressure dried (as opposed to super-critical drying) is used as a reinforcing filler in an elastomeric composition. Surface functionalization of the surface-modified gel by addition of a coupling agent can take place before the gel is contacted with an elastomeric component, or in-situ in the presence of an elastomeric component.

As used herein, the term silica gel refers to, for instance, silica hydrogels, xerogels, or aerogels, or combinations thereof, for example, that are produced by reacting a soluble silicate such as sodium silicate with a strong acid such as hydrochloric or sulfuric acid. Under aqueous conditions, the resulting gel is washed in water to remove residual salt, dried, and then usually micronized by steam treatment to form a hydrogel. Surface modified aerogels are a preferred silica gel for use in the compositions of the present invention and may be made in a traditional manner using supercritical drying where water of the gel is replaced by an alcohol and the gel is heated to remove the alcohol under super critical drying conditions, such as under high pressure and high temperature in an autoclave. Or alternatively, such aerogels may be produced by hydrophobizing the surface of the silica, subsequent phase transferred of the surface treated silica gel to an immiscible organic liquid, and then dried from the organic liquid at ambient pressure conditions. Contrary to aerogels, xerogels are inorganic hydrated oxides precipitated from an aqueous solution and dried in air or under a vacuum. Preferably, the silica hydrogel contains from about 5% to about 20% by weight silicon dioxide. Preferably, the silica gel is essentially free of other inorganic components, and contains less than 1% of any such components. Preferably, the silica gel is essentially free of inorganic components such as aluminum, iron, magnesium, boron, phosphorus, titanium, zirconium, vanadium, and niobium.

According to an aspect of the present invention, the surface-modified silica gel is surface-functionalized with at least one surface functionalizing agent (e.g., coupling agent). Silica gel functionalizing agents that can be useful according to the present invention include, but are not limited to, silane coupling agents (e.g. monofunctional and/or bifunctional silane coupling agents), such as bis(3-triethoxysilylpropyl)disulfane, bis(3-triethoxysilylpropyl)tetrasulfane (Si-69), 3-thiocyanatopropyl-triethoxy silane (Si-264, from Degussa AG, Germany), γ-mercaptopropyl-trimethoxy silane (A189, from Union Carbide Corp., Danbury, Conn.); zirconate coupling agents, such as zirconium dineoalkanolatodi(3-mercapto) propionato-O (NZ 66A, from Kenrich Petrochemicals, Inc., of Bayonne, N.J.); titanate coupling agents; nitro coupling agents such as N,N′-bis(2-methyl-2-nitropropyl)-1,6-diaminohexane (Sumifine 1162, from Sumitomo Chemical Co., Japan); polyalkoxysiloxane (e.g. Zeruma from Yokoham, Japan) and mixtures of any of the foregoing. The coupling agents may be provided as a mixture with a suitable carrier, for example X50-S which is a mixture of Si-69 and N330 carbon black, available from Degussa AG. Preferably, the surface-functionalizing agent has a moiety that is reactive towards silanol groups present on the silica gel surface and/or towards Si—O—Si groups or any other active sites or groups, such as an organosilane group. Preferably, the functionalizing agent has a moiety which is reactive with the polymer chains of an elastomeric component, such as, for example, a di- or poly-sulfide or a mercaptan moiety. Surface-functionalizing agents having a moiety reactive with the silica gel and a moiety reactive with the elastomer are preferred as they couple or connect the silica gel to the elastomer in a manner which enables the silica gel to more effectively reinforce the elastomer.

Exemplary surface-functionalizing agents that can be used according to the present invention include, for example, silane coupling agents which contain a di- or poly-sulfide. Alkoxysilylalkyl di- or poly-sulfides can be used, such as bis-(3-triethoxysilylpropyl) tetrasulfide, which has a silane moiety which is reactive with silanols of the silica gel and a tetrasulfide moiety which is reactive with polymer chains of a sulfur curable elastomer, for instance. Dithiodipropionic acid, for example, may also be considered for use as a surface-functionalizing modifying agent either individually or, for example, in combination with a silane polysulfide coupling agent.

Elastomeric components which can be reinforced with the surface-modified silica gel fillers in accordance with the present invention include various solution polymerization-prepared, as well as emulsion polymerization-prepared, diene based elastomers, for example, natural and synthetic cis 1,4-polyisoprene rubber, cis 1,4-polybutadiene rubber, styrene/butadiene copolymer rubber, butadiene/isobutylene copolymer rubber, EPDM rubber, styrene/isoprene/butadiene terpolymer rubber, butadiene/acrylonitrile rubber, 3,4-polyisoprene rubber, isoprene/butadiene copolymer rubber, and combinations thereof. Other examples include homo- or co-polymers of 1,3 butadiene, styrene, isoprene, isobutylene, 2,3-dimethyl-1,3-butadiene, acrylonitrile, ethylene, and propylene Preferably, the elastomer has a glass transition temperature (Tg) as measured by differential scanning colorimetry (DSC) ranging from about −120° C. to about 0° C. Examples include, but are not limited, styrene-butadiene rubber (SBR), natural rubber, polybutadiene, polyisoprene, and their oil-extended derivatives. Blends of any of the foregoing may also be used.

Among the rubbers suitable for use with the present invention are natural rubber and its derivatives such as chlorinated rubber. The surface-modified silica gel fillers in accordance with the present invention may also be used with synthetic rubbers such as: copolymers of from about 10 to about 70 percent by weight of styrene and from about 90 to about 30 percent by weight of butadiene such as a copolymer of 19 parts styrene and 81 parts butadiene, a copolymer of 30 parts styrene and 70 parts butadiene, a copolymer of 43 parts styrene and 57 parts butadiene and a copolymer of 50 parts styrene and 50 parts butadiene; polymers and copolymers of conjugated dienes such as polybutadiene, polyisoprene, polychloroprene, and the like, and copolymers of such conjugated dienes with an ethylenic group-containing monomer copolymerizable therewith such as styrene, methyl styrene, chlorostyrene, acrylonitrile, 2-vinyl-pyridine, 5-methyl 2-vinylpyridine, 5-ethyl-2-vinylpyridine, 2-methyl-5-vinylpyridine, alkyl-substituted acrylates, vinyl ketone, methyl isopropenyl ketone, methyl vinyl either, alphamethylene carboxylic acids and the esters and amides thereof such as acrylic acid and dialkylacrylic acid amide; also suitable for use herein are copolymers of ethylene and other high alpha olefins such as propylene, butene-1 and pentene-1.

The rubber compositions of the present invention can therefore contain an elastomer, curing agents, reinforcing filler, a coupling agent, and, optionally, various processing aids, oil extenders, and antidegradents. In addition to the examples mentioned above, the elastomer can be, but is not limited to, polymers (e.g., homopolymers, copolymers, and terpolymers) manufactured from 1,3 butadiene, styrene, isoprene, isobutylene, 2,3-dimethyl-1,3 butadiene, acrylonitrile, ethylene, propylene, and the like. It is preferred that these elastomers have a glass transition point (Tg), as measured by DSC, between −120° C. and 0° C. Examples of such elastomers include poly(butadiene), poly(styrene-co-butadiene), and poly(isoprene).

Elastomeric compositions disclosed in the present invention include, but are not limited to, vulcanized compositions (VR), thermoplastic vulcanizates (TPV), thermoplastic elastomers (TPE) and thermoplastic polyolefins (TPO). TPV, TPE, and TPO materials are further classified by their ability to be extruded and molded several times without loss of performance characteristics.

According to a preferred embodiment of the present invention, at least one elastomeric component, at least one silica aerogel made by surface modification and ambient pressure drying and at least one functionalizing (e.g., coupling) agent are together blended and mixed under conditions such that surface functionalization of the silica gel occurs in-situ in the presence of the elastomeric components. This process avoids the need of a time-consuming surface pretreatment of the surface modified silica gel with functionalizing agent.

According to an embodiment of the present invention, a vulcanizable rubber composition is provided and includes (A) 100 parts by weight of at least one diene based elastomer, (B) from about 5 to about 150, preferably from about 30 to about 70, parts by weight of at least one type of surface-modified silica gel, and (C) from about 1% by weight to about 20% by weight, preferably from about 5% by weight to about 10% by weight, of at least one type of silica gel surface functionalizing agent based on the weight of the silica gel.

According to another aspect of the present invention, the silica gel is hydrophobized to form a low density, highly dispersible surface-modified silica aerogel before being combined with an elastomeric component. Resulting compositions are particularly preferred for use as tire and tire component compositions.

According to an embodiment of the present invention, a curable or cured elastomeric composition is provided. Such curable or cured compositions can include vulcanizable rubber compositions for forming a tire or tire component. The curable or cured composition includes (A) 100 parts by weight of at least one type of diene based elastomer, and (B) from about 5 to about 150, preferably from about 30 to about 70, parts by weight of at least one type of surface-modified silica gel or low density surface-modified silica aerogel. The silica gel is preferably functionalized in-situ with from about 1% by weight to about 20% by weight, preferably from about 5% by weight to about 10% by weight, of at least one type of functionalizing agent based on the weight of the silica gel. The silica gel is preferably a low density, high dispersible, readily incorporated, and surface-modified silica aerogel.

The silica gel precursor or base silica material useful according to the present invention may be hydrothermally pretreated in any number of ways. Pretreatment of the base silica may involve adjustment of the solution pH, removal of salt (from, for example, a sodium silicate based sol) by ion-exchange, and heating of the mixture for a specified time and temperature. According to a preferred embodiment of the present invention, the base silica material is heated for from about 1 to about 6 hours at a temperature of about 100° C., and preferably at atmospheric pressure. The pH of the base silica material solution during the pretreatment period can be adjusted to any pH of from about 0 to about 9, to achieve the desired gel structure during the pretreatment step. The pH is adjusted by the addition of appropriate acids or bases. A preferred pH range can be from about 6 to about 8.5. Before, during, or after hydrothermal pretreatment, the silica base material or resulting gel can be sheared in any number of ways, for example, by the use of a rotor-stator homogenizer, a dispersion mill, or a media mill.

To the hydrothermally treated hydrogel is added an inorganic acid, such as HCl, an alcohol such as 2-propanol (IPA), and a surface modifying agent (e.g., a modifier) such as hexamethyl disiloxane (HMDS). The mixture is preferably heated to a temperature of from about 30° C. to about 70° C., and the mixture is allowed to react with the silica surface preferably at acidic conditions in the presence of 2-propanol as a co-solvent.

Upon treatment of the silica, the silica surface becomes hydrophobic. After 30 minutes, an excess of HMDS or other modifier is added to the mixture, and the treated silica will spontaneously phase transfer into the organic solvent phase, that is, into the HMDS phase (or modifier phase).

After ‘pop-out’ or extraction of the silica from the aqueous to the organic phase, the organogel slurry is washed with water, preferably at least twice. The water is allowed to phase separate after mixing, and is subsequently decanted. After washing, the organogel slurry is heated and may be distilled to remove residual water and acid by azeotropic distillation. After distillation, the mixture is dried at ambient pressure conditions to yield a low density, highly dispersible, readily incorporated silica aerogel. Any drying method suitable for solvent removal (e.g., spray drying, thin film drying, and the like) can be used.

With the present invention, the surface modified silica gels are preferably manufactured by surface-modification of a silica gel and ambient pressure drying to form a low density, highly dispersible aerogel. Ambient pressure drying is preferred over super-critical dried aerogels because of the need for a simpler, lower cost aerogel manufacturing step. Furthermore, the aerogels of the present invention are low density, highly dispersible, easily incorporated and inherently hydrophobic and thus require no post treatment to make them hydrophobic in-situ. The surface modification of the gel allows spring-back of the gel structure during drying to give a highly dispersible and easily incorporated silica. With the silica gels of the present invention, particle dispersibility and aggregate break-up can be achieved by a variety of ways. For instance, the surface modified silica gels are naturally hydrophobic and thus show little tendency to large scale aggregation. The hydrophobicity of the silica gel also improves incorporation. Furthermore, because of the low density of the particles, the silica aerogel is highly friable during compounding. Furthermore, the density of the aerogel and the degree of dispersion of the particles during compounding can be controlled by altering the solids content of the silica gels, by adjusting the gelation pH and temperature, and/or by controlling the aging conditions. Thus, the present invention offers a number of advantages over conventional supercritically dried aerogels.

The present inventors have discovered that elastomeric compounds having desirable hysteresis, wet skid resistance, and other properties may be obtained by compounding an elastomer with the surface-modified silica aerogel of the present invention. The present invention also relates to a method of improving the wet-skid resistance of an elastomeric composition. The method includes blending an elastomeric component with at least one surface-modified silica aerogel and at least one functionalizing agent to form a reinforced elastomeric composition or article. The composition or article has greater wet-skid resistance than either the same composition or article containing no surface-modified silica aerogel, or containing the same silica aerogel but without the functionalizing agent. The present invention further provides a method of improving the hysteresis of an elastomeric composition, which includes blending an elastomeric component with at least one surface-modified silica aerogel and at least one functionalizing agent to form a reinforced elastomeric composition or article having lower hysteresis at high temperature than the same elastomeric composition or article containing no surface-modified silica aerogel or containing the same silica aerogel but without the functionalizing agent.

Mixtures of different types of surface-modified silica gels can be used in the various embodiments of the present invention. Further, conventional ingredients, such as conventional fillers, antioxidants, cure agents, and the like can be used.

The present invention may be more fully understood with reference to the following examples. The examples are exemplary only and are not intended to limit the scope of the present invention as set forth in the appended claims.

### EXAMPLES

### Example 1

A surface modified ambient pressure dried, silica aerogel was prepared as follows:

Silica hydrogel containing 8-12% SiO₂ by weight was drained to remove excess interstitial water. 60 kg of the drained silica gel was placed in a 50 gal glass lined steel reactor with stirrer, and approximately 24 liters of 32% HCl was added, along with approximately 33 liters of 2-propanol, and 20 liters of HMDS.

The mixture was allowed to react for 30 minutes at 60° C. As reaction of the HMDS with the silica proceeds, the silica becomes hydrophobic. After the reaction time, the stirrer speed was decreased to a gentle stirring motion and an additional 30 liters of hexamethydisiloxane (HMDS) was added to the reactor, and the hydrophobic silica underwent spontaneous transfer from the aqueous to the organic phase.

The aqueous phase was decanted from the reactor, and 40 liters of fresh water was added to the reactor. The mixture was stirred and then allowed to phase separate. The aqueous phase was again decanted. This was followed by a second washing step.

After washing, the organic mixture was heated and distilled azeotropically at atmospheric pressure to remove any remaining residual acid, water, and immiscible organic phase.

The azeotroped organogel slurry was then spray-dried in a pilot plant spray-drier suitable for use with an organic solvent.

The surface modified silica aerogel was compared to various carbon blacks and a carbon-silica dual phase filler. The analytical properties of these fillers are shown in Table I below.

TABLE I
Analytical Properties of Fillers

| | BET area (N₂) | CDBP |
|---|---|---|
| Filler | m²/g | cL/100 g |
| Carbon black N234 | 121.0 | 101 |
| Carbon black N339 | 87.0 | 96 |
| CSDPF (CRX | 154.3 | 100 |
| 2000) | | |
| Aerogel P-431 | 229.0 | NA |

Aerogel P-431 is a surface-modified aerogel produced by Cabot Corporation according to the method described above. The carbon blacks N234 and N339 were products of Cabot Corporation. CSDPF is a carbon-silica dual phase filler ECOBLACK® CRX 2000 from Cabot Corporation having a silicon content of 4.8 wt % (ECOBLACK and CRX are trademarks of Cabot Corporation).

The Aerogel P-431 and carbon blacks were used to make elastomeric compounds.

The elastomeric compositions were prepared according to the formulations shown below in Table II:

TABLE II
Formulations

| % by wt | Carbon black | CSDPF | Aerogel P431 |
|---|---|---|---|
| OE SSBR (BUNA VSL 5025-1) | 96.25 | 96.25 | 96.25 |
| BR (Taktene 1203) | 30 | 30 | 30 |
| VULCAN 7H | 70 | — | — |
| CSDPF CRX 2000 | — | 70 | — |
| Aerogel P431 | — | — | 70 |
| TESPT (Si 69) | — | 2.0 | 5.6 |
| Oil (Mobilsol 30) | 1.75 | 1.75 | 1.75 |
| Zinc Oxide | 3.5 | 3.5 | 3.5 |
| Stearic Acid | 2 | 2 | 2 |
| Antioxidant (Santoflex 6PPD) | 1 | 1 | 1 |
| Wax (Sunproof Imp) | 3.5 | 3.5 | 3.5 |
| Antioxidant (Wingstay 100) | 1.0 | 1.0 | 1.0 |
| Durax | 1.1 | 1.6 | 2 |
| Vanax DPG | — | 0.5 | 1.6 |
| Sulfur | 1.4 | 1.4 | 1.4 |

Buna VSL 5025-1—oil extended solution SBR from Bayer AG. Germany.
Tacktene 1203—Polybutadiene, from Bayer Fibres, Akron, Ohio.
Si 69 (TESPT)—bis (3-triethoxysilylpropyl) tetrasulfide, from Degussa AG, Germany.
Mobilsol 30—oil, from Mobil Oil Co.,
Zinc oxide—from New Jersey Zinc Co., New Zersey.
Stearic acid—from Emery Chemicals, Cincinnati, Ohio.
Santoflex 6PPD—antioxidant, N-(1,3,-dimethyl butyl)-N′-phenyl-p-phenylene diamine, from Flexsys America L.P., Akron, Ohio.
Sunproof Improved—wax, from Uniroyal Chemical Co. Middlebury, CT
Wingstay 100—antioxidant, mixed diaryl-p-phenylene diamine from R. T. Vanderbilt Co., Norwalk, CT.
Durax—accelerator, N-cycloheane-2-benzothiazole sulphenamide, from R. T. Vanderbilt Co., Norwalk, CT.
Vanax DPG—accelerator, diphenyl guanidine, from R. T. Vanderbilt Co., Norwalk, CT.
TMTD—accelerator, tetramethyl thiuram disulfide, from Uniroyal Chemical Co. Middlebury, CT
Sulfur—from R.E.Carrol Inc., Trenton, New Jersey.

The elastomeric compounds were prepared using a three-stage mixing procedure. The internal mixer used for preparing the compounds was a Banbury B 1600 (obtained from Farrel Corp. Ansonia, Conn.) having a capacity of 1600 ml. In the first stage, the mixer rotor speed was set at 50 rpm. After the mixer was conditioned, the elastomer was loaded and masticated for 1 minute. The filler, pre-blended with oil, and optionally with a coupling agent, was then added. When the temperature reached 90° C., zinc oxide, stearic acid, wax, and antioxidants were added. Mixing was continued until the temperature reached 110° C., followed by sweeping and increasing rotor speed to 80 rpm. When the temperature was raised to 160° C., the rotor speed was reduced, maintaining this temperature for two minutes, and then the stage 1 masterbatch was dumped from the mixer. The masterbatch was then passed through an open mill three times and stored at room temperature for two hours.

In the second stage, the rotor speed was set to 80 rpm and the masterbatch from the first stage was charged into the mixer. The material was dumped when the temperature went up to 160° C. The dumped masterbatch was again passed through an open mill three times and stored at room temperature for two hours.

In the last stage, the rotor speed was set to 50 rpm. After the mixer was conditioned, half of the masterbatch from stage two, with curatives including sulfur, Durax, and DPG, were loaded and mixed. Then, the other half of the masterbatch was charged into the mixer. The material was dumped from the mixer at about two minutes when the temperature reached 110° C. The dumped compound was passed through the open mill three times and sheeted off.

The three stages are summarized in Table III below.

TABLE III
Mixing Procedure for Tread Compounds of Passenger Tire

| | |
|---|---|
| Stage 1 | BR1600, |
| | 50 rpm, Temperature: Wall = 50° C.; rotors = 60° C. |
| 0′ | Add polymer |
| 1′ | Add preblended filler, oil and TESPT (if applied) |
| @90° C. | Add zinc oxide, stearic acid, wax, antioxidant. |
| @110° C. | Sweep, increase rotor speed to 80 rpm. |
| @160° C. | lower rotor speed to maintain 160° C. for 2 minute |
| | Dump after heat treatment. |
| | Pass through open mill 3 times. |
| | Sit at room temperature for at least 2 hrs. |
| Stage 2 | 80 rpm, |
| 0′ | Add masterbatch from stage 1. |
| @160° C. | Dump. |
| | Pass through open mill 3 times. |
| | Sit at room temperature for at least 2 hrs. |
| Stage 3 | 50 rpm, 80° C. air on, start all mixes @ 100° C. |
| 0′ | Add masterbatch from stage 2 and curatives. |
| @110° C. | Dump. |
| | Pass through open mill 3 times. |

The wet skid resistance, dynamic hysteresis, and abrasion resistance rates were measured for the elastomeric compositions produced according to Example 1 above.

The wet skid resistance (or wet traction) was measured by means of an improved British Portable Skid Tester (BPST) with the procedure reported by Ouyang et. al in Carbon Black Effects on Friction Properties of Tread Compound—Using a modified ASTM-E303 Pendulum Skid Tester, presented at the meeting of the Rubber Division, ACS, in Denver, Colo., May 18-21, 1993, incorporated in its entirety herein. The friction coefficients (BPST %) are referenced to a carbon black N234-filled compound (rated at 100%). The higher the number, the higher the wet skid resistance.

Dynamic properties were determined using a Rheometrics Dynamic Spectrometer II (RDS IT, Rheometrics, Inc., N.J.) with strain sweep. The measurements were made at 70° C. with strain sweeps over a range of double strain amplitude (DSA) from 0.2 to 120%. The maximum tan δ values on the strain sweep curves were taken for comparing the hysteresis among elastomeric compounds. The lower the maximum tan δ at 70° C., the lower the rolling resistance of the tire.

Abrasion resistance was determined using an abrader, which is based on a Lambourn-type machine as described in U.S. Pat. No. 4,995,197, hereby incorporated by reference. The tests were carried out at 14% slip. The percentage slip is determined based on the relative velocities of a sample wheel and a grindstone wheel. The abrasion resistance index is calculated from the mass loss of the elastomeric compound. (The higher the abrasion index, the higher the abrasion resistance).

TABLE IV
Physical Properties of Vulcanizates

| | BPST | tan δₘₐₓ | Abrasion index, % |
|---|---|---|---|
| Filler/phr | % | 70° C. | 14% slip |
| Carbon black | 100 | 0.322 | 100 |
| N234 | | | |
| Carbon black | 101 | 0.311 | 88 |
| N339 | | | |
| CSDPF | 102 | 0.176 | 104 |
| CRX 2000 | | | |
| Aerogel P-431 | 107 | 0.157 | 99 |

Table IV shows that the in-situ functionalized silica aerogel-filled elastomeric product imparts improved wet skid resistance and hysterisis over the carbon black filled compounds.

It will be apparent to those skilled in the art that various modifications and variations can be made to the embodiments of the present invention described herein without departing from the spirit or scope of the present invention. Thus, it is intended that the present invention cover other modifications and variations of this invention within the scope of the appended claims and their equivalents.

What is claimed is:

1. A tire or tire component comprising an elastomeric composition comprising at least one elastomeric component and at least one surface-modified silica gel.

2. The tire or tire component of claim 1, wherein said surface-modified silica gel is essentially free of inorganic components other than silicon dioxide.

3. The tire or tire component of claim 1, wherein said elastomeric component comprises at least one polymer manufactured from 1,3 butadiene, styrene and its derivatives, isoprene, isobutylene, 2,3-dimethyl-1,3 butadiene, acrylonitrile, ethylene, propylene, a natural polymer.

4. The tire or tire component of claim 1, wherein said surface-modified silica gel is present in said elastomeric composition in an amount of from about 30 parts by weight to about 100 parts by weight per 100 parts by weight of the elastomeric component.

5. An elastomeric composition comprising a) at least one elastomeric component b) at least one surface-modified silica gel that has been formed in the presence of said elastomeric component, and c) optionally a filler material comprising carbon black, silica, silicon treated carbon black, carbon black having attached at least one organic group, or combinations thereof.

6. The elastomeric composition of claim 5, wherein said composition further comprises at least one functionalizing agent.

7. The elastomeric composition of claim 5, wherein said surface-modified silica gel has a surface area of from about 50 to about 900 m²/gm.

8. The elastomeric composition of claim 5, wherein said silica gel is a surface modified, ambient pressure dried, highly dispersible silica aerogel.

9. The elastomeric composition of claim 5, wherein said surface-modified silica gel is silica gel surface-modified with at least one organosilicon composition.

10. The elastomeric composition of claim 5, wherein said surface-modified silica gel is silica gel surface-modified with at least one functional organosiloxane component.

11. A tire or tire component formed from the elastomeric composition of claim 5.

12. A tire tread formed from the elastomeric composition of claim 5.

13. A method of making a reinforced elastomeric composition comprising;
blending at least one elastomeric component, at least one surface-modified silica gel, and at least one surface-functionalizing agent together to form a blend; and subjecting said blend to conditions under which the surface-functionalizing agent reacts with said silica gel to form a surface-functionalized silica gel in the presence of said elastomeric component.

14. The method of claim 13, wherein said surface-modified silica gel is a surface-modified silica aerogel.

15. The method of claim 13, wherein said silica gel surface-functionalizing agent comprises at least one functional organosilane composition.

16. The method of claim 13, wherein said silica gel surface-functionalizing agent comprises at least one alkoxysilylalkyl di- or poly-sulfide.

17. The method of claim 13, wherein said silica gel functionalizing agent comprises bis (3-triethoxysilylpropyl) tetrasulfide or bis (3-triethoxysilylpropyl) disulfide.

18. The method of claim 13, wherein said elastomeric component comprises at least one polymer manufactured from 1,3 butadiene, styrene and its derivatives, isoprene, isobutylene, 2,3-dimethyl-1,3 butadiene, acrylonitrile, ethylene, propylene, a natural polymer.

19. The method of claim 13, further comprising forming said blend into a tire or tire component

20. The method of claim 13, wherein said elastomeric component comprises at least one styrene-butadiene rubber.

21. The method of claim 13, wherein said conditions comprise a temperature of greater than about 110° C.

22. The method of clam 13, wherein said surface modified silica gel has a surface area of from about 50 to about 900 m²/gm.

23. A method of improving the wet-skid resistance of an elastomeric composition, comprising:
blending an elastomeric composition with at least one surface-modified, ambient pressure dried, highly dispersible silica gel component and at least one functionalizing agent to form a reinforced blend; and
forming said blend into an elastomeric component having a higher wet-skid resistance than either the same elastomeric composition containing no surface-modified silica gel, or containing the same silica gel but without surface-functionalization.

24. The method of claim 23, wherein said surface-functionalized silica gel is formed from reacting a surface-modified silica gel and a functionalizing agent in the presence of said elastomeric composition.

25. A method of improving the hysterisis of an elastomeric composition, comprising:
blending an elastomeric composition with at least one surface-modified, ambient pressure dried, highly dispersible silica gel component and at least one functionalizing agent to form a reinforced blend; and
forming said blend into an elastomeric component having a higher wet-skid resistance than either the same elastomeric composition containing no surface-modified silica gel, or containing the same silica gel but without surface-functionalization.

26. The method of claim 25, wherein said surface-functionalized silica gel is formed from reacting a surface modified silica gel and a surface-functionalizing agent in the presence of said elastomeric composition.
